(19) United States
(12) Patent Application Publication
(10) Pub. No.: US 2015/0369581 A1
(43) Pub. Date: Dec. 24, 2015

(54) SYSTEM AND METHOD FOR CHECKING DIMENSIONS AND/OR POSITION OF AN EDGE OF A WORKPIECE

(71) Applicant: MARPOSS SOCIETA' PER AZIONI, Bentivoglio (BO) (IT)

(72) Inventor: Roberto Toso, Ferrara (IT)

(73) Assignee: Marposs Societa' Per Azioni, Bentivoglio (Bo) (IT)

(21) Appl. No.: 14/650,477

(22) PCT Filed: Dec. 20, 2013
(86) PCT No.: PCT/EP2013/077795

§ 371 Date: Jun. 8, 2015

(30) Foreign Application Priority Data
Dec. 20, 2012 (IT) BO2012A000691
Dec. 20, 2012 (IT) BO2012A000693

(51) Int. Cl. G01B 3/46; G01B 5/12

(52) U.S. Cl. CPC G01B 3/46; G01B 5/12

(57) ABSTRACT

A system for checking size and/or position of an edge (5, R, T) of a workpiece (1, 1R, 1T) comprises two checking elements including matching elements (6, 7; 16, 17) which comprise respective surfaces having tapered matching zones (8, 9) adapted to cooperate with the edge (5, R, T) of the workpiece (1, 1R, 1T) along a longitudinal direction, and a transducer element (11) that provides electrical signals (M, M6, M7) indicative of the cooperation between the matching zones and the edge. The matching zones define slope angles (α, β) with respect to the longitudinal direction that are different from each other. A method that uses such a system for checking includes bringing the matching elements in a checking condition in which the respective matching zone cooperates with the edge to be checked, detecting the electrical signals provided by the transducer element, and processing such signals with reference signals indicative of the cooperation between each matching zone and a reference edge. System and method can be advantageously applied in checking the diameter of an edge of a valve seat (2).

### TECHNICAL FIELD

The present invention relates to a system and a method for checking dimensions and/or position of an edge of a workpiece, with respect to a reference position.

In particular, the present invention can advantageously, but not exclusively, be applied in checking the diameter of circular edges of an object, the circular edges being originated from the intersection of two surfaces having rotational symmetry. The object can be, for example, in an internal combustion engine, a component of an injection system with a valve seat comprising the edge to be checked, or a valve seat in the cylinder head, or a valve intended to be housed in such seat. Reference to checking of an internal edge of a valve seat will be explicitly made in the following specification without loss of generality.

### PRIOR ART

In its most spread form, a valve seat comprises a tapered sealing surface connected to a cylindrical guide aperture. The tapered sealing surface, intended to cooperate with the valve head, typically comprises two or more adjacent conical surfaces, each of which slopes down of a certain angle with respect to the central axis of the seat itself. The contact between the valve head, which defines a conical surface in turn, and the circular edge originated from two adjacent conical surfaces realizes the seal.

Checking very carefully the dimensions of the parts most directly involved in the operation of the system is worthwhile, in particular of the operating surfaces, and, among them, of the circular edge. Indeed, possible modifications with respect to the nominal dimensions are responsible of a not proper cooperation between the valve and the relevant seat, with resulting loss of seal, leakages, decrease of the engine performance and increase of the levels of exit discharge.

The known to date techniques for checking operating surfaces which may include the circular edge use different technologies and are mainly of two types. A first known checking technique is of contact type, such as that shown in the U.S. patent application published with the number US2010119104A1, wherein, for example, a touch probe is used, that scans the object in a number of points sufficient to reconstruct a digital image on the basis of which the features of the object are analyzed. This type of checking, however, generally implies the run of a high number of data which, in most cases, requires expensive tools and/or long processing times. Moreover, it can not be used for checking valve seats having small dimensions. A second known checking technique is of non-contact type, such as that shown in the U.S. Pat. No. 7,643,151B2, wherein, for example, optical measurement devices are used, that take advantage of the interferometric technique to digitally reconstruct the image of the object on which the checking is run. However, this second known technique is, among other things, extremely sensitive to vibrations and dirt, and generally not suitable for checking in workshop environment.

In addition, a point-scanning of the operating surfaces of the object is run in both known techniques. The discrete data thus obtained can be, for example, interpolated to reconstruct the image of the object. Except for the fortuitous and unlikely event that one of the scanning points samples the profile of the operating surfaces exactly at the junction edge, a position depending on the point-scanning and on the interpolation formula will be associated to the edge, such position being usually different from the real one and not taking into account imperfections in manufacturing, wear or deposition of material.

### DISCLOSURE OF THE INVENTION

Object of the present invention is to provide a system and a method for quantitatively and accurately defining radial position of the edge of an object with respect to a reference position, such system and such method being free from the previously described inconveniences and, concurrently, easily and cheaply implemented.

According to the present invention, this and other objects are achieved by systems and methods for checking according to the attached claims, which are an integral part of this description.

A system according to the present invention comprises: a support and locating frame, checking elements connected to the support and locating frame, a transducer system connected to the checking elements, and a processing unit connected to the transducer system. The checking elements include two matching elements which comprise respective surfaces having tapered matching zones to cooperate with the edge, and the matching zones define slope angles with respect to the longitudinal direction which are different from each other; the transducer system comprises at least one transducer element, which provides electrical signals indicative of the cooperation between the matching elements and the edge of the object; the processing unit receives the electrical signals and processes them in order to determine the radial position of the edge with respect to a reference position.

Preferably, the matching zones are sloped surfaces featuring the slope angles, for example cone-shaped or pyramid-shaped with a polygonal base. Alternatively, the matching zones are substantially spherical with different radii and adapted to cooperate with the edge so as to define tangential planes featuring the slope angles.

A system according to the present invention, for example for checking the diametrical dimension of a circular edge, can include two feelers embodying the two matching elements and adapted to touch the edge to be checked. The feelers can be connected to the support and locating frame by means of at least one shaft, and the transducer element can be connected to the shaft and provide electrical signals indicative of the longitudinal position of the shaft and of the matching elements that it brings.

Advantageously, the shaft is equipped with structural features for automatically centering each of the two matching elements with the workpiece, in particular with the circular edge, with respect to a longitudinal direction.

The matching elements of a system according to the present invention may have structural features such that the matching zones can cooperate simultaneously or in a substantially simultaneous way with the edge to be checked. Alternatively, a system according to the present invention can be of the fluid type and comprise a source of pressure fluid (i.e. gas), and a mechanism for positioning the matching elements, which defines preset positions of said matching elements along the longitudinal direction. In this case the electrical signals provided by the transducer element (i.e. a pneumo-electrical converter) are indicative of variations of features (i.e. flow rate or pressure) of said pressure fluid passing through a cooperation zone delimited by the matching zone of each matching element and the edge to be checked.

Preferably, the support and locating frame includes two checking stations, each of which comprises a transducer element and one of the two matching elements.

As an alternative, the support and locating frame may include a Coordinate Measuring Machine, which alternatively mounts the matching elements on a movable arm and perform sequential checkings of the workpiece.

In a method according to the present invention, in order to perform checkings by means of a system with the features so far mentioned, the matching elements are brought in a checking condition wherein the respective matching zone cooperates with the edge to be checked, for example it leans on such edge, signals provided by the transducer system and indicative of cooperation between each matching zone and the edge to be checked are detected, for example signals relative to the longitudinal position of the matching elements in the checking condition, and these signals are processed together with reference signals indicative of the cooperation between each matching zone and a reference edge, in order to determine the radial gap of the edge with respect to the reference edge.

Objects and advantages of the present invention will be clear from the detailed description that follows, concerning a preferred embodiment of the invention, given only by way of non-restrictive example, with reference to the attached drawings.

### BRIEF DESCRIPTION OF THE DRAWINGS

The present invention is now described with reference to the attached sheets of drawings, given by way of non-limiting examples, wherein:

FIG. 1 schematically represents a system for checking according to a possible embodiment of the present invention, with a partially sectioned workpiece to be checked;

FIG. 2 schematically illustrates the operating principle of the system for checking shown in FIG. 1 according to the present invention;

FIGS. 3a and 3b schematically show two different conditions of a method for checking the radial position of the edge of an object with respect to a reference position according to the present invention; and

FIG. 4 schematically illustrates two different conditions of said method for checking using the system shown in FIG. 1,

FIG. 5 schematically illustrates two different conditions of said method for checking using a system for checking according to a possible embodiment of the present invention alternative to that shown in FIG. 1.

### BEST MODE FOR CARRYING OUT THE INVENTION

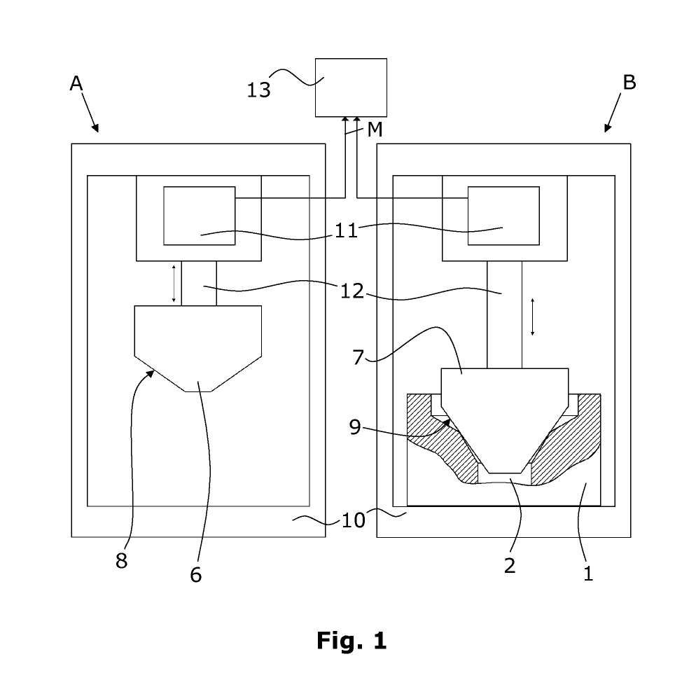

FIG. 1 shows the main components of a system for checking the radial position of an edge of a workpiece 1, in particular for checking the diametral dimensions of an injection system for internal combustion engine, with a valve seat 2 that defines a longitudinal axis. The system includes, for example, a support and locating frame 10 that comprises two checking stations A and B essentially identical, each of which includes a checking element connected to the support and locating frame 10, a transducer element, i.e. an inductive transducer, schematically represented in FIG. 1 and referred to with reference 11, and a shaft 12 connected to the inductive transducer 11 and axially movable with respect to the support and locating frame 10. The transducer elements of the two checking stations A and B are part of the same transducer system. Each checking element includes a matching element, in particular a feeler 6 (7), substantially having rotational symmetry, that is connected to one free end of the shaft 12 and comprises a surface having a tapered matching zone, in particular a sloped, for example cone-shaped, matching surface 8 (9). The feelers 6 and 7 of the two checking stations A and B differ from one another for a different inclination of the respective matching surface 8 and 9. A processing unit 13, comprising display devices, is connected to the inductive transducers 11 from which it receives electrical signals M indicative of the cooperation between the matching surfaces 8, 9 and the edge 5, in particular of the longitudinal position of the respective shaft 12, that is of the longitudinal position of the feelers 6 and 7.

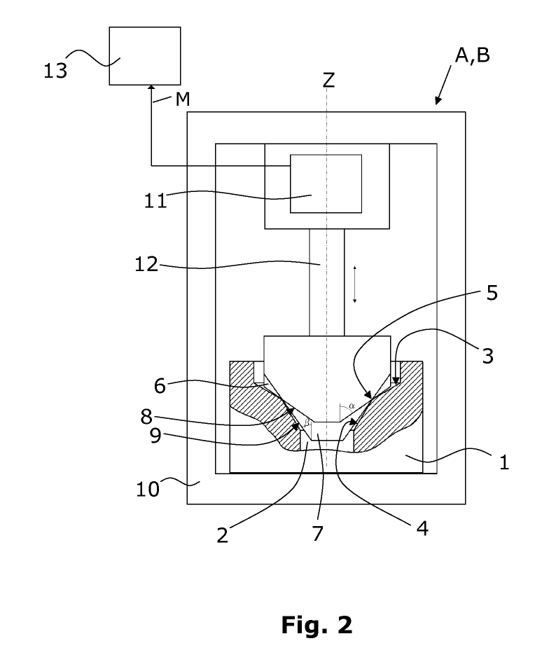

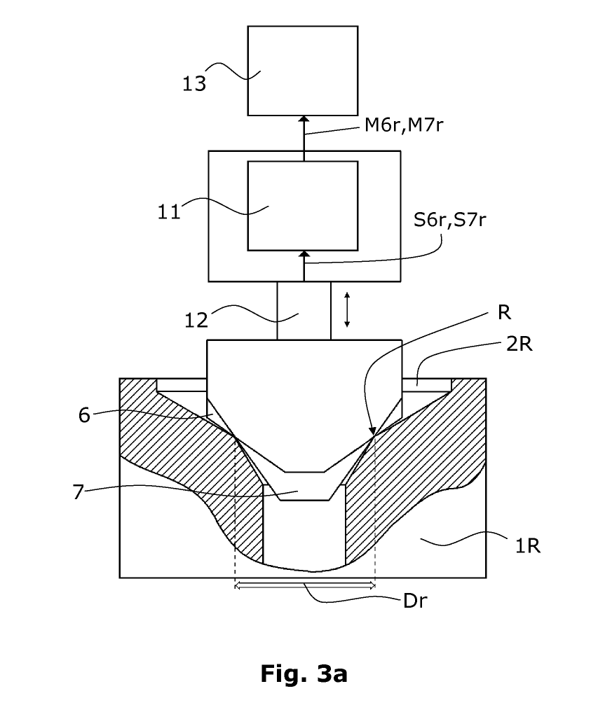

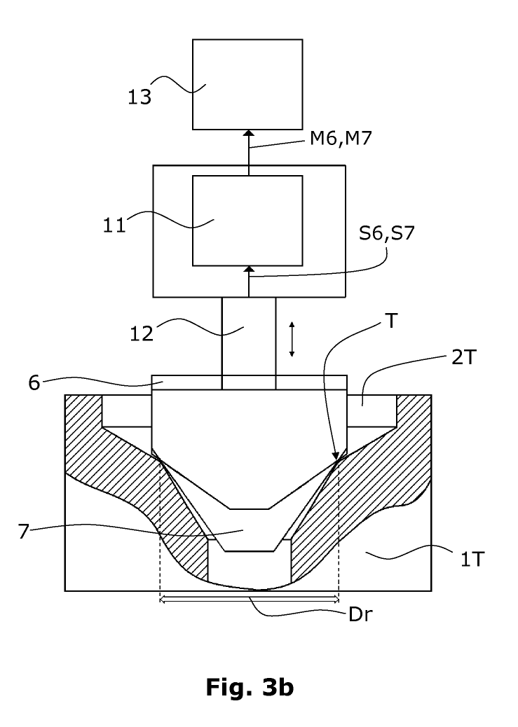

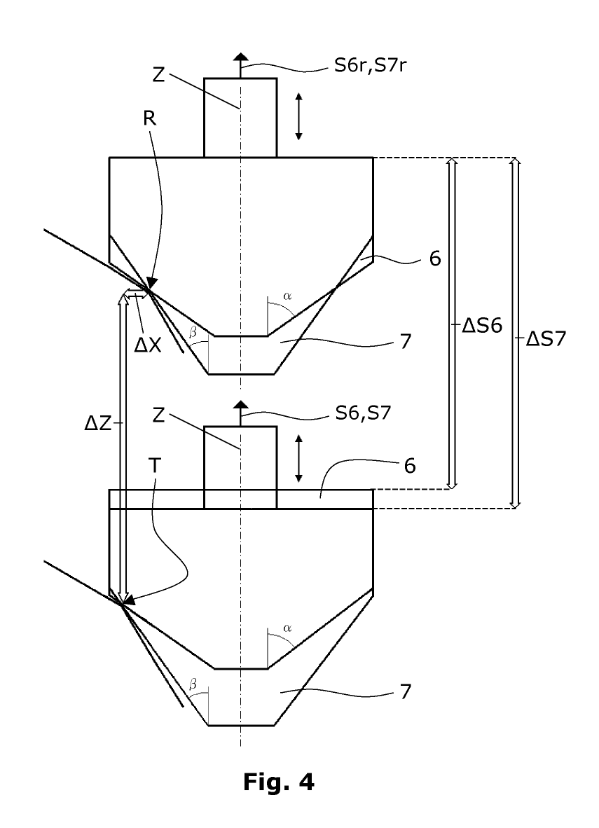

To better illustrate the operation of the system according to the invention, FIG. 2 schematically shows the feelers 6 and 7 superimposed while checking the same workpiece 1 in the respective checking station A and B (as well as FIGS. 3a, 3b and 4 that will be taken into account hereinbelow). The shaft 12 defines an axis Z that, during the checking of the workpiece 1, is substantially overlapped to the longitudinal axis of the seat 2 thanks to proper reference systems for the workpiece 1, belonging to the checking stations and not shown in figure. Typically, the shaft 12 is properly sized and has structural features of small flexibility that enable limited transverse displacements of the relative feeler 6 or 7, in order to ensure the centering of said feeler with respect to the workpiece 1, enabling the overlapping of the axis Z of the shaft 12 to the longitudinal axis of the seat 2.

With respect to the axis Z, the matching surface 8 of the feeler 6 has a slope angle α, whereas the matching surface 9 of the feeler 7 has a slope angle μ.

The seat 2 comprises two surfaces substantially cone-shaped, in particular a central surface 3 and an internal surface 4. Generally, with respect to the longitudinal axis defined by the seat 2, the central surface 3 has a wide slope angle, i.e. greater than 45°, whereas the internal surface 4 has a smaller slope angle, i.e. less than 45°. The intersection between the central surface 3 and the internal surface 4 defines a circular edge 5, whose diametral dimensions have to be checked. The slope angle α of the matching surface 8 that identifies the feeler 6 is a little bit smaller than the slope angle of the central surface 3 of the seat 2, whereas the slope angle μ of the matching surface 9 that identifies the feeler 7 is smaller than both of them but a little bit greater than the slope angle of the internal surface 4.

In its own checking station, each of the feelers 6 and 7 can make forward/backward movements along the axis Z to perform longitudinal displacements, is urged into contact with the edge 5 and assumes positions that depend on the longitudinal position and diametral dimensions of the edge 5. In each of the checking stations A and B wherein the workpiece 1 is sequentially checked, the shaft 12 transmits to the inductive transducer 11 the longitudinal displacements of the respective feeler 6 and 7. The inductive transducer 11 sends electrical signals M to the processing unit 13, such electrical signals M being indicative of the longitudinal position of the shafts 12, that is of the feeler 6 or 7, respectively. The processing unit 13 processes the electrical signals M coming from both checking stations A and B in order to detect the difference between the diametral dimensions of the circular edge 5 and nominal diametral dimensions, and shows them in a display. A method for checking the radial position of the edge of an object according to the present invention is described in the following with reference to the FIGS. 3a and 3b. For example, checking the radial position of a circular edge T of a seat 2T belonging to an object 1T may be functional in checking the diametral dimension D of said circular edge T, the centering of the feelers 6 and 7 with respect to the workpiece to be checked, that is the substantial overlapping of the axis Z to the longitudinal axis of the seat 2T, being ensured. The embodiment that follows, shows such application of the method according to the present invention.

The method can comprise a preliminary calibration condition and at least one subsequent checking condition. During the calibration condition, each of the feelers 6 and 7 within the respective checking station A and B, not shown in FIGS. 3a and 3b, is brought in a calibration position defined by the contact between the respective matching surface 8 and 9 and a reference circular edge R of a seat 2R of a calibration master 1R, such reference circular edge R having known reference diametral dimension Dr. In this calibration condition, the inductive transducer 11 transmits reference signals M6r (and M7r) indicative of a reference longitudinal position S6r (and S7r) of the relative feeler 6 (and 7) to the processing unit 13, which stores them and links them to said reference diametral dimension Dr. During the checking condition, each of the feelers 6 and 7 within the respective checking station A and B is brought in a control position defined by the contact of the respective matching surface 8 and 9 with the circular edge T to be checked. The inductive transducer 11 transmits to the processing unit 13 electrical signals M6 (and M7) indicative of the longitudinal position S6 (and S7) of the relative feeler 6 (and 7). The processing unit 13, processing the electrical signals M6 and M7 together with the reference signals M6r and M7r, compares the longitudinal positions S6 and S7 with the reference longitudinal positions S6r and S7r. From this comparison, and from the known geometrical features of the two feelers 6 and 7 used, in particular the slope angles α and μ of the respective matching surfaces 8 and 9, the processing unit 13 evaluates the difference between the reference diametral dimension Dr and the diametral dimension D to be checked. Knowing the reference diametral dimension Dr and such difference, the diametral dimension D can be determined in easy and accurate way.

In order to better illustrate the method for checking the radial position of the edge of an object according to the present invention, the schematic of FIG. 4 is referred to, wherein the distance between the reference circular edge R and the circular edge T to be checked is intentionally and excessively oversized for the sake of simplicity. Said distance can be decomposed into a longitudinal component ΔZ and a radial component ΔX.

During the calibration condition, for example, the feeler 6 (and 7), moving forward along the axis Z within its own checking station A (and B) not shown in FIG. 4, is urged into contact with the reference circular edge R, in a reference longitudinal position S6r (and S7r) that the processing unit 13 links to the reference diametral dimension Dr. Also for the sake of simplicity, in the top of the schematic of FIG. 4 the feelers 6 and 7 show plane upper surfaces that are aligned when the respective matching surfaces 8 and 9 cooperate with the reference circular edge R. In the checking condition, the feeler 6 (and 7), moving forward along the axis Z, is urged into contact with the circular edge T to be checked, in a longitudinal position S6 (and S7).

ΔS6 and ΔS7 are the differences of the longitudinal positions S6 and S7 of the matching elements 6 and 7 in said checking condition with respect to the reference longitudinal positions S6r and S7r, respectively ΔS6=S6−S6r and ΔS7=S7−S7r. The amount of ΔS6 and ΔS7 is due both to the longitudinal component ΔZ and the radial component ΔX of the distance between the circular edges R and T. As the contribution of the longitudinal component ΔZ is the same for both the feelers 6 and 7, that of the radial component ΔX is different when using one feeler 6 or the other 7, and is connected to the slope angles α and μ of the matching surfaces 8 and 9.

In particular, the longitudinal positions of the feelers 6 and 7 undergo variations equal to

ΔS6=ΔZ+ΔX/tan gα

and

ΔS7=ΔZ+ΔX/tan gμ

respectively.

Deriving from both formulae the expression of the longitudinal component ΔZ and matching the second members of the derived expressions, the expression of the radial component ΔX can be obtained in easy and accurate way, i.e.

$$Δ X = \frac{tan g α \cdot tan g β}{( tan g α \cdot tan g β )} \cdot [ Δ S7 - Δ S 6 ] .$$

From the radial component ΔX calculated this way, that is the radial gap of the circular edge T to be checked with respect to the reference edge R, and from the reference diametral dimension Dr, the diametral dimension D can be determined, by applying for example the formula

D=Dr+2·ΔX.

A system for checking according to the present invention can also be used, for example, for checking the radial position of an edge originated from the intersection of two surfaces that complies with at least one of the following conditions: the central surface 3 is flat and perpendicular to the longitudinal axis of the seat 2, or the internal surface 4 is cylindrical and parallel to the same axis.

A system for checking according to the present invention can present various structural modifications as compared with what is schematically described above.

For example, the support and locating frame 10 can include a lock mechanism for locking the workpiece 1. Such lock mechanism can have structural features that enable restricted transversal displacements of the workpiece 1 itself, in order to ensure the overlapping of the axis Z of the shaft 12 to the longitudinal axis of the seat 2 of said workpiece 1, in replacement of or in addition to the mentioned features of small flexibility of the shaft 12.

In a system according to the present invention, the feelers 6 and 7 can exhibit tapered matching zones 8 and 9 with shape other than conical, for example pyramidal with a polygonal base. In this case, in a method for checking like that so far illustrated, without substantial differences, it is assumed that the contact between the feelers 6 and 7 and the circular edge 5 (and R and T) occurs at converging edges of the pyramidal shape. As an alternative, the matching zones 8 and 9 can be substantially spherical, the radii being different from each other. In this further case, the matching zones 8 and 9 are adapted to cooperate with the edge 5 so as to define tangential planes featuring the slope angles α and μ, and the method for checking is still like that so far illustrated, without substantial differences.

According to a possible embodiment different from that illustrated hitherto, in a system according to the present invention the feelers 6 and 7 can have such structural features that they can cooperate simultaneously or in a substantially simultaneous way with the edge to be checked. For example, one of the feelers 6 (or 7) can be provided with an internal recess, for housing the other feeler 7 (or 6), and transit holes on the matching surface 8 (or 9), for enabling portions of the matching surface 9 (or 8) of the other feeler 7 (or 6), conveniently shaped, to protrude and be radially aligned with portions of the matching surface 8 (or 9) of the first feeler 6 (or 7). In this case, a method for checking is different from what previously described only in that the cooperation between the feeler 6 and the edge 5 (and R and T) and the cooperation between the feeler 7 and the same edge 5 (and R and T) can occur in an essentially simultaneous way. This alternative solution enables the time for checking to be reduced.

Other possible systems for checking according to the present invention have feelers with different shape, for example with internal matching zones for checking external diameters, and can be used for checking the edge of a valve intended to house in a relative seat with the task of closing the intake and discharge ducts that are headed to the combustion chamber in the cylinder head of an internal combustion engine. Other possible systems for checking according to the present invention can exhibit different structural modifications for further types of checking of dimensions or position of edges, closed or open, having profiles different from that illustrated in the figures.

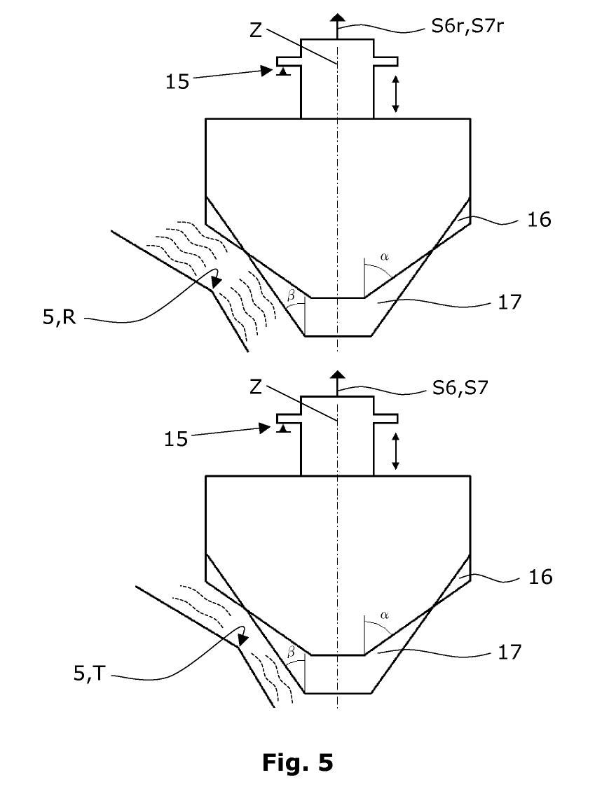

In a different embodiment of the invention, shown in FIG. 5, a fluidic, for example pneumatic, system for checking enables the checking to be executed without directly contacting the workpiece 1, and the feelers 6 and 7 can be substituted for example with two matching elements 16 and 17 that do not touch the edge 5 to be checked but are intended to assume, thanks to a suitable locating mechanism 15, preset positions along the longitudinal direction, wherein the respective tapered matching surfaces are facing such edge 5 and delimit a cooperation zone with it. The matching elements 16 and 17 keep the structural features of the feelers 6 and 7, in particular they comprise respective surfaces having tapered matching zones 8 and 9 that distinguish from each other for the different slope angles α and μ that they define with respect to the axis Z. A source of a pressure fluid, i.e. a gas source, not shown in figure, belongs to said system for checking, and the transducer element is for example a pneumo-electrical converter that, for both matching elements, detects variations of features of the pressure fluid, i.e. variations of pressure or flow rate (the fluid being represented with dotted curved lines in figure), in said cooperation zone, transforms such variations in electrical signals M and sends the latter to the processing unit 13. A method for checking according to such different embodiment can include, similarly to what previously described, a preliminary calibration condition and a subsequent checking condition. In each condition, the two matching elements are sequentially brought in a calibration position, or in a control position, which in both cases is defined by said preset position along the longitudinal direction, set for example from the contact with an abutment plane or element that realizes the so-called locating mechanism 15. In such preset position, in calibration condition the matching elements 16 and 17 lie at a known and nonzero distance from the reference circular edge R, in checking condition the matching elements 16 and 17 lie at an unknown distance from the circular edge T to be checked. It is pointed out that the amount of such known and unknown distances as shown in FIG. 5 is by far exaggerated, for the sake of clearness, with respect to the reality. In each condition and for each matching element 16 (17), pneumo-electrical converter performs the checking on the basis of the cooperation between matching surface and edge, more specifically on the basis of variations of the features of the fluid passing through the cooperation zone between the matching surface and the edge, in a manner known per se, and transmits the results to the processing unit 13. The processing unit 13 processes such electrical signals and the information known a priori, in particular the slope angles α and μ, to determine the difference between the reference diametral dimension Dr and the diametral dimension D to be checked.

As an alternative to the two checking stations A and B, the system can include a Coordinate Measuring Machine, or CMM, for sequentially checking a workpiece whose exact position is known instant by instant. Such CMM can comprise in a manner known per se a storage wherein the matching elements 6 and 7 are arranged, a suitable automatic change mechanism and a device for locking them. In this embodiment, the matching elements 6 and 7 are alternatively mounted on the movable arm of the CMM to cooperate with the calibration master 1R at first, then with the workpiece 1T to be checked. The method for checking is one of those previously described.

In a method according to the present invention, the reference longitudinal positions S6r and S7r can be obtained as described hitherto at each checking operation, or result from calibration operations performed just once at the beginning of the checking of a series of workpieces and/or periodically performed after a certain amount of checked workpieces, or can be a data known a priori. Advantages resulting from the application of the present invention are clear.

First of all, a system and a method according to the invention enable the position or the dimensions of an edge to be directly checked, avoiding indirect checkings of the adjacent surfaces and consequent interpolations.

This is also the reason why the number of data to run for the checking is significantly lower with respect to that required by the technique known to date.

Consequently, and due to the application of an analytical formula which is function of the known geometric features of the matching elements used, times are greatly reduced. The matching elements can be chosen for checking dimensions also of very small pieces.

The system object of the present invention has simple, robust and compact components, and is little sensitive to disturbances (vibrations, dirt) that are present in workshop environment.

1. A system for checking dimensions and/or position of an edge of a workpiece, comprising:
a support and locating frame,
checking elements connected to said support and locating frame, adapted to cooperate with said workpiece along a longitudinal direction,
a transducer system connected to said checking elements, and
a processing unit connected to said transducer system,
wherein:
said checking elements comprise two matching elements which comprise respective surfaces having tapered matching zones, adapted to cooperate with said edge and define slope angles with respect to said longitudinal direction which are different from each other,
said transducer system comprises at least one transducer element, which provides electrical signals indicative of the cooperation between said matching zones and said edge,
said processing unit being adapted to receive said electrical signals and process them in order to determine a radial position of said edge with respect to a reference position.

2. The system according to claim 1, wherein said two matching zones have rotational symmetry.

3. The System according to claim 2, wherein said matching zones are sloped surfaces featuring said slope angles.

4. The System according to claim 2, wherein said matching zones are substantially spherical, the radii of such substantially spherical matching zones being different from each other, and are adapted to cooperate with said edge so as to define tangential planes featuring said slope angles.

5. The System according to claim 1, wherein said matching zones are pyramid-shaped with a polygonal base.

6. The system according to claim 1, wherein said two matching elements are feelers adapted to touch said edge to be checked, said at least one transducer element being adapted to provide electrical signals indicative of a longitudinal position of the matching elements.

7. The system according to claim 6, wherein said feelers are connected to said support and locating frame by means of at least one shaft, and said at least one transducer element is connected to said at least one shaft and is adapted to provide electrical signals indicative of the longitudinal position of said at least one shaft.

8. The System according to claim 7, for checking diametrical dimensions of a circular edge, wherein said shaft has structural features adapted to enable the centering of said two matching elements with said workpiece along said longitudinal direction.

9. The system according to claim 6, wherein said two matching elements have structural features adapted to enable the cooperation of said two matching zones with said edge of said workpiece in a substantially simultaneous way.

10. The system according to claim 1, comprising a source of a pressure fluid, wherein said checking elements comprise a locating mechanism for positioning the matching elements, adapted to define preset positions of said matching elements along said longitudinal direction, the electrical signals provided by said at least one transducer element being indicative of variations of features of said pressure fluid passing through a cooperation zone delimited by the matching zone of each matching element and the edge to be checked.

11. The system according to claim 10, wherein said pressure fluid is a gas and the transducer element is a pneumo-electrical converter.

12. The system according to any one of the preceding claim 1, wherein said support and locating frame comprises two checking stations, each of said checking stations including a transducer element and one of said matching elements.

13. The system according to claim 1, wherein said support and locating frame comprises a coordinate measuring machine with a movable arm, said matching elements being adapted to be alternatively connected to the movable arm in order to perform sequential checkings of said workpiece.

14. A method for checking position and/or dimensions of an edge of a workpiece, by means of a system with two matching elements which define respective surfaces having tapered matching zones adapted to cooperate with the edge to be checked along a longitudinal direction and define slope angles with respect to said longitudinal direction which are different from each other, and a transducer system adapted to provide electrical signals indicative of the cooperation between said matching zones and said edge, the method including the steps of:
bringing each of said matching elements in a checking condition, wherein the respective matching zone cooperates with the edge to be checked,
detecting signals provided by the transducer system and indicative of cooperation between each matching zone and the edge to be checked, and
processing said signals and reference signals indicative of cooperation between each matching zone and a reference edge, in order to determine the radial gap of the edge to be checked with respect to the reference edge.

15. The method according to claim 14, wherein said matching elements are sequentially brought in said checking condition.

16. The method according to claim 14, wherein each matching element is moved forward along said longitudinal direction up to the checking condition defined by the contact between the respective matching zone and the edge to be checked, said signals being indicative of a longitudinal position of the matching elements, and said reference signals being indicative of a reference longitudinal position defined by the contact between each matching zone and the reference edge.

17. The method according to claim 16, wherein said matching elements are connected to at least one shaft, said signals being indicative of the longitudinal position of said at least one shaft.

18. The method according to claim 16, wherein said radial gap is achieved by means of the following formula
ΔX=tan gα·tan gβ·[ΔS7−ΔS6],
(tan gα−tan gβ
where
α and β are the slope angles defined by the matching zones with respect to said longitudinal direction, and
ΔS7 and ΔS6 are the differences of the longitudinal positions of the matching elements in said checking condition with respect to the reference longitudinal positions.

19. The method according to claim 14, by means of a system including a source of pressure fluid, wherein each of said matching elements is moved forward along the longitudinal direction up to a preset position which defines said checking condition, said signals provided by the transducer system being indicative of variations of features of said pressure fluid passing through a cooperation zone delimited by the matching zone of each matching element and the edge to be checked.

20. The method according to claim 14, for checking diametrical dimension of a circular edge by means of matching elements having matching zones which are substantially sloped.

21. The method according to claim 20, for checking internal edges.

22. The method according to claim 14, including the further steps of
bringing each of said matching elements in a calibration condition wherein the respective matching zone cooperates with the reference edge, and
detecting said reference signals as signals provided by the transducer system and indicative of the cooperation between each matching zone and the reference edge.
